(19) United States
(12) Patent Application Publication
(10) Pub. No.: US 2025/0211422 A1
(43) Pub. Date: Jun. 26, 2025

(54) LINEAR CONVERTER, BLOCK ENCRYPTION AND/OR DECRYPTION CIRCUITS AND CHIP

(71) Applicant: Montage LZ Technologies (Chengdu) Co., Ltd., Chengdu (CN)

(72) Inventors: Weike RAO, Chengdu (CN); Rui YANG, Chengdu (CN); Jipeng XIONG, Chengdu (CN); Haihua WEN, Chengdu (CN); Chiachen CHANG, Chengdu (CN)

(73) Assignee: Montage LZ Technologies (Chengdu) Co., Ltd., Chengdu (CN)

(21) Appl. No.: 18/823,649

(22) Filed: Sep. 3, 2024

(30) Foreign Application Priority Data
Dec. 26, 2023 (CN) 2023118256401

(51) Int. Cl. H04L 9/06

(52) U.S. Cl. CPC H04L 9/0631

(57) ABSTRACT

A linear converter, block encryption/decryption circuits, and a chip. The linear converter multiplies the data block in the block encryption and/or decryption circuits with the constant coefficient matrix in the Galois Field for one time to obtain the linear transformation result, and elements in the constant coefficient matrix are obtained according to transformation coefficients of the basic transformation. The linear converter can reduce the delay of the block encryption and/or decryption process.

### FIELD OF TECHNOLOGY

The present disclosure belongs to the field of information encryption technology and relates to a linear converter, in particular to a linear converter, block encryption/decryption circuits, and a chip.

### BACKGROUND

Block encryption and decryption techniques, widely adopted as means of data protection in the field of cryptography, play a crucial role in areas such as digital communication, data storage, and computer security. They involve dividing the data to be encrypted into fixed-size data blocks, followed by independently encrypting and decrypting each data block, thereby providing reliable protection for the confidentiality of the data. In the embodiment of block encryption and decryption technology, performing linear transformation process on data blocks are indispensable steps. However, in current existing technologies, the operation pipeline for linear transformations is relatively lengthy, leading to significant delays in the process of block encryption or decryption.

### SUMMARY

The present disclosure provides a linear converter, block encryption/decryption circuits, and a chip for reducing delay in a block encryption or decryption process.

A first aspect of the present disclosure provides the linear converter, wherein the linear converter is configured to multiply a data block in the block encryption and/or decryption circuits with a constant coefficient matrix in the Galois Field for one time to obtain a linear transformation result, and elements in the constant coefficient matrix are obtained according to transformation coefficients of a basic transformation.

In one embodiment of the first aspect, the linear converter comprises n Exclusive-OR (XOR) combinational logic circuits, each of the XOR combinational logic circuits is configured to perform operations (including XOR operations) on corresponding data bits in the data block in stage to obtain 1 byte of data in the linear transformation result, wherein n is a positive integer, and n is determined by the quantity of data bits comprised in the data block.

In one embodiment of the first aspect, the XOR combinational logic circuits comprise multiple XOR gates, and the quantity of XOR gates and their corresponding data bits are determined by corresponding elements in the constant coefficient matrix.

In one embodiment of the first aspect, the XOR combinational logic circuits comprise multiple stages of XOR combinational logic units, each stage of the XOR combinational logic units comprises at least one XOR gate.

In one embodiment of the first aspect, multiple XOR gates in XOR combinational logic units of the same stage perform XOR operation of the input data bits in a parallel manner.

In one embodiment of the first aspect, the n XOR combinational logic circuits obtain n data bits of the linear transformation result in parallel.

In one embodiment of the first aspect, the length of the data block is 128 bits.

In one embodiment of the first aspect, the constant coefficient matrix is determined by: determining a transformation matrix C based on R(a)=(l(a_{ƒ-1}, a_{ƒ-2}, . . . , a₀)∥a_{ƒ-1}∥. . . ∥a₁) and the transformation coefficients of the basic transformation l, in stage to get R(a)=[a_{ƒ-1}, a_{ƒ-2}, . . . , a₀]⊗C, wherein R represents the linear transformation, l represents the basic transformation, a represents the data block, aᵢ represents the i-th byte of the data block a, and ƒ represents the quantity of bytes of the data block a; determining the constant coefficient matrix based on the transformation matrix C and a quantity of rounds nr for which R is to be transformed.

In one embodiment of the first aspect, the constant coefficient matrix is equivalent to the transformation matrix C raised to the power of nr.

A second aspect of the present disclosure provides a block encryption circuit comprising: a round function module, configured to perform multiple rounds of operation on plaintext data to obtain encrypted intermediate data; and a key imposition module, configured to process the encrypted intermediate data using a key to obtain a ciphertext; wherein, the round function module comprises a key imposition unit, a non-linear substitution unit, and the linear converter as previously described in any one of the embodiments of the first aspect.

A third aspect of the present disclosure provides a block decryption circuit comprising: an inverse round function module, configured to perform multiple rounds of operation on ciphertext data to obtain decrypted intermediate data; and a key imposition module, configured to process the decrypted intermediate data using a key to obtain plaintext; wherein, the inverse round function module comprises a key imposition unit, a non-linear substitution unit, and an inverse linear transformation unit, wherein the inverse linear transformation unit comprises the linear converter as previously described in any one of the embodiments of the first aspect.

A fourth aspect of the present disclosure provides a chip comprising: the linear converter as previously described in any one of the embodiments of the first aspect, the block encryption circuit as previously described in any one of the embodiments of the second aspect, or the block decryption circuit as previously described in any one of the embodiments of the third aspect.

As previously described, embodiments of the present disclosure provide the linear converter, the block encryption and/or decryption circuits, and the chip. The linear converter has the following advantages:

(1) The presently disclosed linear converter multiplies the data block in the block encryption and/or decryption circuits with the constant coefficient matrix in the Galois Field for one time to obtain the linear transformation result. This method can effectively shorten the length of the linear transformation process, which is conducive to reducing the delay of the block encryption or decryption process.

(2) The presently disclosed linear converter can be implemented using n Exclusive-OR (XOR) combinational logic circuits, wherein the n XOR combinational logic circuits obtain n data bits of the linear transformation result in parallel. In addition, the n XOR combinational logic circuits may be implemented by using the multiple stages of XOR combinational logic units. When the XOR combinational logic circuits contain multiple XOR gates, these XOR gates can perform XOR operation of the input data bits in a parallel manner. In the above manner, the delay of the combinational logic can be effectively reduced, thereby further reducing the delay of the block encryption or decryption process.

(3) The presently disclosed linear converter performs the linear transformations independently of substitution tables, thus eliminating the need for additional resources to calculate and store substitution tables, which is advantageous for reducing resource overhead.

(4) The presently disclosed linear converter also has the advantages of small hardware size and low cost.

### BRIEF DESCRIPTION OF THE DRAWINGS

FIG. 1 is a circuit diagram of a block encryption and/or decryption circuit according to the GOST R 34.12.

FIG. 2 is a schematic diagram of a R transformation.

FIG. 3 is a schematic diagram showing implementation of linear transformation in some existing technical solutions.

FIG. 4 is a schematic diagram of an exemplary process of a linear transformation in an embodiment of the present disclosure.

FIG. 5 is a schematic diagram of an exemplary structure of a linear converter in an embodiment of the present disclosure.

FIG. 6 is a schematic diagram of multiple stages of XOR combinational logic units in an embodiment of the present disclosure.

FIG. 7A is a schematic diagram of an exemplary structure of a block encryption circuit in an embodiment of the present disclosure.

FIG. 7B is a schematic diagram of a block encryption process in an embodiment of the present disclosure.

FIG. 8A is a schematic diagram of an exemplary structure of a block decryption circuit in an embodiment of the present disclosure.

FIG. 8B is a schematic diagram of a block decryption process in an embodiment of the present disclosure.

### DETAILED DESCRIPTION

The embodiments of the present disclosure will be described below. Those skilled can easily understand disclosure advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and the features of the following embodiments can be combinational with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual embodiment; during the actual embodiment, the type, quantity and proportion of each component can be changed as needed, and the layout of the components can also be more complicated.

There are many standards for block encryption and decryption technology, such as Advanced Encryption Standard (AES), Data Encryption Standard (DES), GOST R 34.12, etc. The following will introduce block encryption and decryption techniques using GOST R 34.12 as an example.

GOST R 34.12 uses a Substitution-Permutation Network (SPN) structure, which includes substitution layers, permutation layers, and round-key addition. In each round of encryption processes, the data is first mapped by eight substitution boxes through the substitution layer. The substitution boxes are configured to map 8-bit input data to another 8-bit data for the purpose of obfuscation. Subsequently, the data passes through the permutation layer, and the data bits at different locations are rearranged by a permutation operation. After the permutation operation is completed, a round key is introduced, and the key of each round is generated by a key scheduling algorithm to ensure that the encryption operation in each round is affected by different keys.

The linear transformation is one of the key steps in GOST R 34.12. It introduces elements of linear operation by performing bitwise XOR operation on the output of the substitution layer and the round key, effectively obfuscating the data bits. Through the linear transformation, the ability of the algorithm to resist attacks such as differential and linear cryptanalysis can be improved. The entire encryption process is implemented through multiple iterations, each of which comprises substitutions, permutations, and the linear transformations.

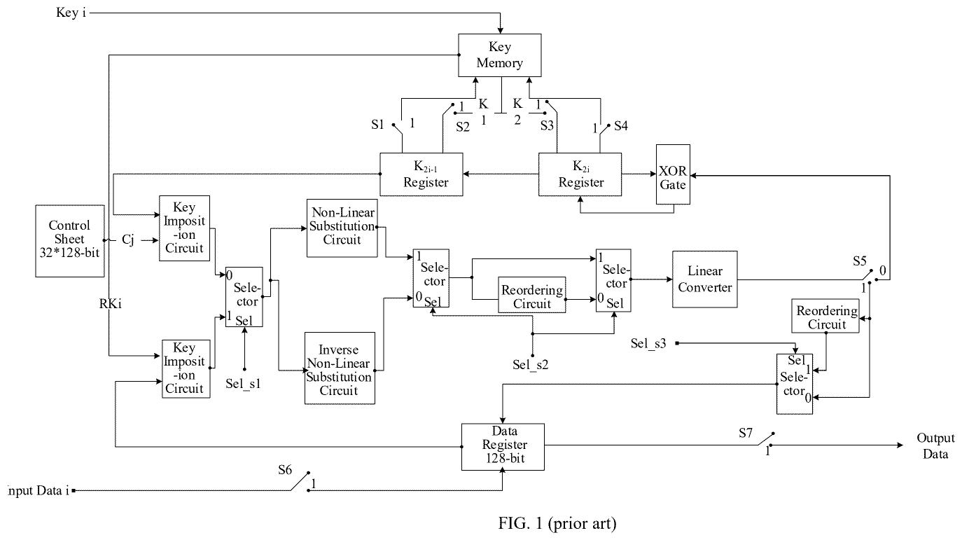

FIG. 1 is a circuit diagram of a block encryption and/or decryption circuit according to GOST R 34.12.\. As shown in FIG. 1, the circuit mainly includes key imposition circuits, a non-linear substitution circuit, an inverse non-linear substitution circuit, a linear converter, reordering circuits, selectors, switches S1 to S7, an XOR gate, a memory, and registers. The connection relationship between these devices is shown in FIG. 1. The switches S1 to S7 are configured to be turned on or turned off under the control of the control signal. The selectors are configured to communicate the corresponding circuits under the control of the selection signals Sel_s1 to Sel_s3.

In the circuit shown in FIG. 1, the linear converter is configured to perform a linear transformation of the data. The linear transformation is performed in the GF (2⁸) field with the following expression: L(a)=R¹⁶(a)=R¹⁶(a₁₅∥. . . ∥a₀).

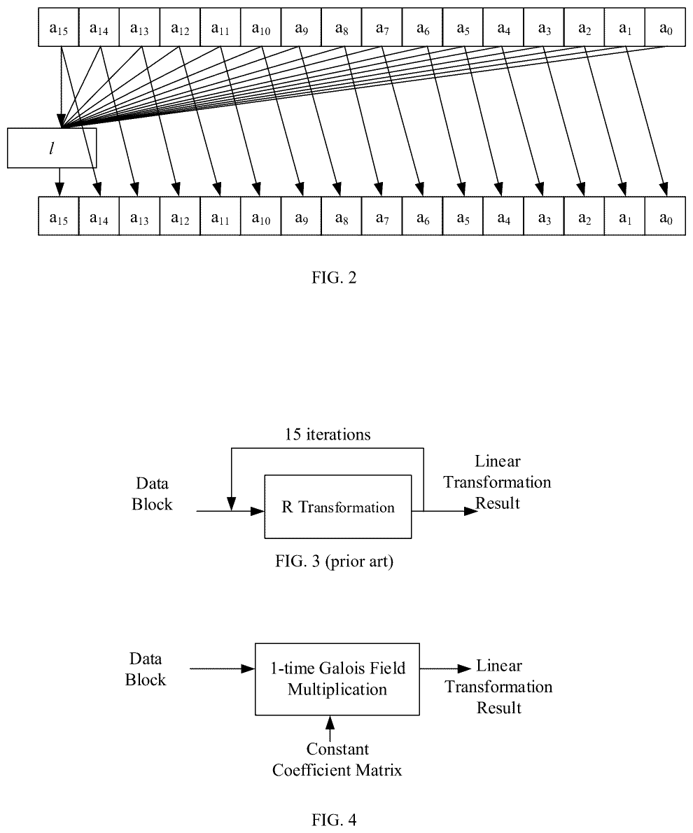

R(a)=(l(a₁₅, . . . , a₀)∥a₁₅∥a₁₄. . . a₂∥a₁) as shown in FIG. 2. R¹⁶(a) represents that sixteen rounds of R transformations (i.e., linear transformations) need to be performed iteratively. For the initial round of R transformation, a represents the initial data block input into the linear converter for undergoing R transformation. For R transformations other than the initial round, a represents the output data block of the previous round of R transformation. aᵢ represents an i-th byte of the data block a, and l represents a basic transformation.

As shown in FIG. 3, in some technical solutions, the linear transformation of GOST R 34.12 can be achieved by applying sixteen rounds of R transformation sequentially to the data block to be transformed. However, these technical solutions require sixteen rounds of transformations to obtain the transformation results, which increases the length of the operation flow, thereby leading to significant delays in the block encryption or decryption process.

In other technical solutions, the linear transformation in GOST R 34.12 can be achieved by the Borodin method/pre-computation tables. Specifically, these technical solutions decompose the linear transformation into a collection of operations that can be independently executed, which then calculate sixteen substitution tables B0˜B15 comprising 256 values in total. The linear transformation can be achieved quickly by aggregating these values. However, the embodiment of such technical solutions relies on sixteen substitution tables, and calculating and storing these substitution tables requires a large amount of resources, resulting in higher implementation costs for these technical solutions.

In light of the above problems, embodiments of the present disclosure provide a linear converter applied to block encryption and/or decryption circuits. For example, the linear converter of the present disclosure can be applied to the circuit shown in FIG. 1 to implement the linear transformation according to GOST R 34.12.

Next, the principle of the embodiments of the present disclosure will be introduced. As mentioned earlier, the expression for the R transformation is as follows: R(a)=(l(a₁₅, . . . , a₀)∥a₁₅∥a₁₄. . . a₂∥a₁)
wherein,

l(a₁₅, . . . , a₀)=q₀⊗(a₁₅)+q₁⊗(a₁₄)+q₂⊗(a₁₃)+q₃⊗(a₁₂)+q₄⊗(a₁₁)+q₅⊗(a₁₀)+q₆⊗(a₉)+q₇⊗(a₈)+q₈⊗(a₇)+q₉⊗(a₆)+q₁₀⊗(a₅)+q₁₁⊗(a₄)+q₁₂⊗(a₃)+q₁₃⊗(a₂)+q₁₄⊗(a₁)+q₁₅⊗(a₀),

i.e.,

$$l ( {a}_{15} , … , {a}_{0} ) = ( {a}_{15} , {a}_{14} , … , {a}_{0} ) ⊗ [ \begin{matrix}{q}_{0} \\ {q}_{1} \\ … \\ {q}_{15}\end{matrix} ]$$

Specifically, l is basic transformation, q₀, q₁, . . . , q₁₅ are the transformation coefficients and ⊗ is the multiplication symbol of the Galois Field.

By substituting the above l(a₁₅, . . . , a₀) into R(a)=(l(a₁₅, . . . , a₀)∥a₁₅∥a₁₄. . . a₂∥a₁), we have:

$$R ( a ) = ( {a}_{15} , {a}_{14} , … , {a}_{0} ) ⊗ [ \begin{matrix}{q}_{0} & 1 & 0 & … & 0 & 0 \\ {q}_{1} & 0 & 1 & … & 0 & 0 \\ … & … & … & … & … & … \\ {q}_{14} & 0 & 0 & … & 0 & 1 \\ {q}_{15} & 0 & 0 & … & 0 & 0\end{matrix} ] = \vec{a} ⊗ C$$

wherein, \vec{a} represents a vector formed by the various bytes of input data block a. This embodiment of the present disclosure is illustrated using an input data block a containing 16 bytes, where \vec{a} represents a vector formed by the 16 bytes (a₁₅, a₁₄, . . . , a₀) of the input data block a. C represents a matrix formed according to the transformation coefficients.

R²(a) is another round of transformation applied to the result of R(a), i.e.: R²(a)=R(R(a))=(\vec{a}⊗C)⊗C=\vec{a}⊗C².

Similarly, it can be concluded that L(a)=R¹⁶(a)=\vec{a}⊗C¹⁶.

From this, it can be observed that in this embodiment of the application, the transformation result is obtained by multiplying vector \vec{a} with C¹⁶.

FIG. 4 is a schematic diagram of the process of a linear transformation by a linear converter in an embodiment of the present disclosure. As shown in FIG. 4, the linear transformation result can be obtained by multiplying the data block in the block encryption and/or decryption circuits with the constant coefficient matrix for one time in the Galois Field. Wherein, elements in the constant coefficient matrix are obtained according to transformation coefficients of the basic transformation l. In this way, the present disclosure only requires one Galois Field multiplication operation to obtain the linear transformation result, which effectively shortens the length of the linear transformation operation flow, thereby reducing delay of block encryption or decryption process. In addition, when using the linear converter provided by the present disclosure for linear transformation operation, the values in the substitution tables are not required, thus eliminating the need to calculate and store the substitution tables, which helps reduce resource consumption.

As shown in FIG. 5. In some embodiments, the linear converter includes n XOR combinational logic circuits, where n is a positive integer, n can be determined according to the quantity of data bits input to the data block of the linear converter. For example, when the data block is 16 bytes, n equals to 128. Each XOR combinational logic circuit includes multiple cascaded XOR gates that are configured to each perform an XOR operation on data bits of the input XOR combinational logic circuit or intermediate data generated in the XOR combinational logic circuit, each of the XOR combinational logic circuits is configured to perform an XOR operation on the corresponding data bits in the data block to obtain 1-bit data of the linear transformation result. For example, the XOR combinational logic circuit 1 is configured to perform an XOR operation on the m_1 data bits in the data block to obtain the first data bit of the linear transformation result, the XOR combinational logic circuit 2 is configured to perform an XOR operation on the m_2 data bits in the data block to obtain the second data bit of the linear transformation result, . . . , the XOR combinational logic circuit n is configured to perform an XOR operation on the m_n data bits in the data block to obtain the n-th data bit of the linear transformation result, wherein m_1, m_2, . . . , m_n are positive integers. The linear transformation result can be obtained based on the above-mentioned n data bits.

In some embodiments, the quantity of XOR gates included in the XOR combinational logic circuit and their input data bits are determined by corresponding elements in the constant coefficient matrix.

In some embodiments, the XOR combinational logic circuit includes multiple stages of XOR combinational logic units. Each stage of the XOR combinational logic units includes one or more XOR gates.

In some embodiments, the XOR combinational logic units include multiple stages of XOR gates, and multiple XOR gates in XOR combinational logic unit of the same stage may perform XOR operations on the input data bits in a parallel manner.

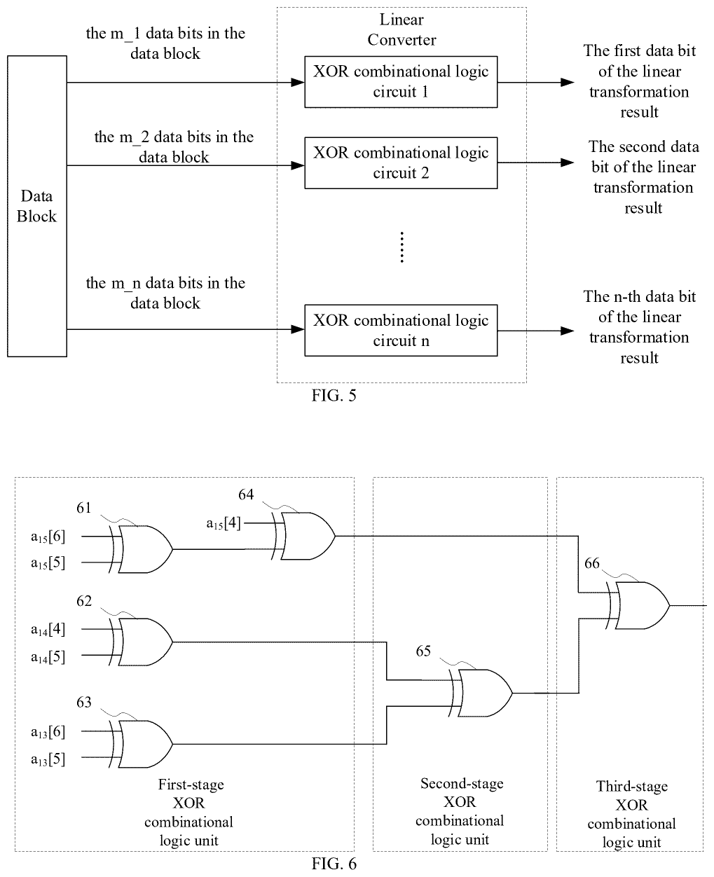

For example, FIG. 6 is a schematic diagram of an XOR combinational logic unit, wherein aᵢ[j] represents the j-th data bit of the i-th byte aᵢ in the input data block a. As shown in FIG. 6, the first-stage XOR combinational logic unit includes four XOR gates, the second-stage XOR combinational logic unit includes one XOR gate, and the third-stage XOR combinational logic unit includes one XOR gate. Specifically, the first-stage XOR combinational logic unit includes XOR gates 61 to 64 for calculating a₁₅[6]\hat{ } a₁₅[5]\hat{ }a₁₅[4], a₁₄[4]\hat{ } a₁₄[5], a₁₃[6]\hat{ } a₁₃[5]. The second-stage XOR combinational logic unit includes XOR gate 65 for calculating (a₁₄[4]\hat{ } a₁₄[5])\hat{ }(a₁₃[6]\hat{ } a₁₃[5]). The third-stage XOR combinational logic unit includes an XOR gate 66 for calculating (a₁₅[6]\hat{ } a₁₅[5] \hat{ }a₁₅[4])\hat{ }((a₁₄[4]\hat{ } a₁₄[5])\hat{ }(a₁₃[6]\hat{ } a₁₃[5])) where “\hat{ }” represents an XOR operation.

In some embodiments, the n XOR combinational logic circuits obtain n data bits of the linear transformation result in parallel. Taking the linear converter shown in FIG. 5 as an example, the XOR combinational logic circuits 1 to n can process the input data bits in a parallel manner to obtain n data bits of the linear transformation result.

In some embodiments, the constant coefficient matrix is determined by: determining a transformation matrix c based on R(a)=(l(a_{ƒ-1}, a_{ƒ-2}, . . . , a₀)∥a_{ƒ-1}∥. . . ∥a₁) and transformation coefficients of a basic transformation l, to get R(a)=[a_{ƒ-1}, a_{ƒ-2}, . . . , a₀]⊗C, wherein R represents a linear transformation, l represents the basic transformation, a represents the data block, aᵢ represents the i -th byte of the data block a, and ƒ represents the quantity of bytes of the data block a, determining the constant coefficient matrix based on the transformation matrix C and the quantity of rounds nr for which R is to be transformed.

Specifically, the constant coefficient matrix is equivalent to the transformation matrix C raised to the power of nr. For example, when sixteen rounds of transformation are required, the constant coefficient matrix is C¹⁶.

The linear converter provided by the embodiment of the present disclosure and its principle will be described in detail by a specific embodiment. It should be noted that this example does not restrict the scope of this disclosure. In this embodiment, the sixteen transformation coefficients q0, q1, . . . q15 of the basic transformation l can be [148, 32, 133, 16, 194, 192, 1, 251, 1, 192, 194, 16, 133, 32, 148, 1]^{T}. The present disclosure is not limited to this, those skilled in the art can understand that in practice, different transformation coefficients can be selected according to actual needs. The basic transformation l is shown as:

l(a₁₅, . . . , a₀)=148⊗(a₁₅)+32⊗(a₁₄)+133⊗(a₁₃)+16⊗(a₁₂)+194⊗(a₁₁)+192⊗(a₁₀)+1⊗(a₉)+251⊗(a₈)+1⊗(a₇)+192⊗(a₆)+194⊗(a₅)+16⊗(a₄)+133⊗(a₃)+32⊗(a₂)+148⊗(a₁)+1⊗(a₀)

In the above equation, addition and multiplication operations are performed in the GF(2⁸) Field, where ⊗ represents the symbol for multiplication in the Galois Field.

Based on the basic transformation l, it can be seen that

$$R ( a ) = ( {a}_{15} , {a}_{14} , … , {a}_{0} ) ⊗ [ \begin{matrix}{q}_{0} & 1 & 0 & … & 0 & 0 \\ {q}_{1} & 0 & 1 & … & 0 & 0 \\ … & … & … & … & … & … \\ {q}_{14} & 0 & 0 & … & 0 & 1 \\ {q}_{15} & 0 & 0 & … & 0 & 0\end{matrix} ] = \vec{a} ⊗ C .$$

L(a)=R¹⁶(a)=\vec{a}⊗C¹⁶

The constant coefficient matrix C¹⁶ is:

| | | | | | | | | | | | | | | | | | |
|---|---|---|---|---|---|---|---|---|---|---|---|---|---|---|---|---|---|
| | 207 | 110 | 162 | 118 | 114 | 108 | 72 | 122 | 184 | 93 | 39 | 189 | 16 | 221 | 132 | 148 | |
| | 152 | 32 | 200 | 51 | 242 | 118 | 213 | 230 | 73 | 212 | 159 | 149 | 233 | 153 | 45 | 32 | |
| | 116 | 198 | 135 | 16 | 107 | 236 | 98 | 78 | 135 | 184 | 190 | 94 | 208 | 117 | 116 | 133 | |
| | 191 | 218 | 112 | 12 | 202 | 12 | 23 | 26 | 20 | 47 | 104 | 48 | 217 | 202 | 150 | 16 | |
| | 147 | 144 | 104 | 28 | 32 | 197 | 6 | 187 | 203 | 141 | 26 | 233 | 243 | 151 | 93 | 194 | |
| | 142 | 72 | 67 | 17 | 235 | 188 | 45 | 46 | 141 | 18 | 124 | 96 | 148 | 68 | 119 | 192 | |
| | 242 | 137 | 28 | 214 | 2 | 175 | 196 | 241 | 171 | 238 | 173 | 191 | 61 | 90 | 111 | 1 | |
| | 243 | 156 | 43 | 106 | 164 | 110 | 231 | 190 | 73 | 246 | 201 | 16 | 175 | 224 | 222 | 251 | |
| {open oversize bracket} | 10 | 193 | 161 | 166 | 141 | 163 | 213 | 212 | 9 | 8 | 132 | 239 | 123 | 48 | 84 | 1 | {close oversize bracket} |
| | 191 | 100 | 99 | 215 | 212 | 225 | 235 | 175 | 108 | 84 | 47 | 57 | 255 | 166 | 180 | 192 | |
| | 246 | 184 | 48 | 246 | 194 | 144 | 153 | 55 | 42 | 15 | 235 | 236 | 100 | 49 | 141 | 194 | |
| | 169 | 45 | 107 | 73 | 1 | 88 | 120 | 177 | 1 | 243 | 254 | 145 | 145 | 211 | 209 | 16 | |
| | 234 | 134 | 159 | 7 | 101 | 14 | 82 | 212 | 96 | 152 | 198 | 127 | 82 | 223 | 68 | 133 | |
| | 142 | 68 | 48 | 20 | 221 | 2 | 245 | 42 | 142 | 200 | 72 | 72 | 248 | 72 | 60 | 32 | |
| | 77 | 208 | 227 | 232 | 76 | 195 | 22 | 110 | 75 | 127 | 162 | 137 | 13 | 100 | 165 | 148 | |
| | 110 | 162 | 118 | 114 | 108 | 72 | 122 | 184 | 93 | 39 | 189 | 16 | 221 | 132 | 148 | 1 | |

Based on the above constant coefficient matrix, the expression for each byte in the linear transformation result can be obtained as follows:

c₁₅=a₁₅⊗207+a₁₄⊗152+a₁₃⊗116+a₁₂⊗191+a₁₁⊗147+a₁₀⊗142+a₉⊗242+a₈⊗243+a₇⊗10+a₆⊗191+a₅⊗246+a₄⊗169+a₃⊗234+a₂⊗142+a₁⊗77+a₀⊗110

c₁₄=a₁₅⊗110+a₁₄⊗32+a₁₃⊗198+a₁₂⊗218+a₁₁⊗144+a₁₀⊗72+a₉⊗137+a₈⊗156+a₇⊗193+a₆⊗100+a₅⊗184+a₄⊗45+a₃⊗134+a₂⊗68+a₁⊗208+a₀⊗162

c₁₃=a₁₅⊗162+a₁₄⊗200+a₁₃⊗135+a₁₂⊗112+a₁₁⊗104+a₁₀⊗67+a₉⊗28+a₈⊗43+a₇⊗161+a₆⊗99+a₅⊗48+a₄⊗107+a₃⊗159+a₂⊗48+a₁⊗227+a₀⊗118

c₁₂=a₁₅⊗118+a₁₄⊗51+a₁₃⊗16+a₁₂⊗12+a₁₁⊗28+a₁₀⊗17+a₉⊗214+a₈⊗106+a₇⊗166+a₆⊗215+a₅⊗246+a₄⊗73+a₃⊗7+a₂⊗20+a₁⊗232+a₀⊗114

c₁₁=a₁₅⊗114+a₁₄⊗242+a₁₃⊗107+a₁₂⊗202+a₁₁⊗32+a₁₀⊗235+a₉⊗2+a₈⊗164+a₇⊗141+a₆⊗212+a₅⊗196+a₄⊗1+a₃⊗101+a₂⊗221+a₁⊗76+a₀⊗108

c₁₀=a₁₅⊗108+a₁₄⊗118+a₁₃⊗236+a₁₂⊗12+a₁₁⊗197+a₁₀⊗188+a₉⊗175+a₈⊗110+a₇⊗163+a₆⊗225+a₅⊗144+a₄⊗88+a₃⊗14+a₂⊗2+a₁⊗195+a₀⊗72

c₉=a₁₅⊗72+a₁₄⊗213+a₁₃⊗98+a₁₂⊗23+a₁₁⊗6+a₁₀⊗45+a₉⊗196+a₈⊗231+a₇⊗213+a₆⊗235+a₅⊗153+a₄⊗120+a₃⊗82+a₂⊗245+a₁⊗22+a₀⊗122

c₈=a₁₅⊗122+a₁₄⊗230+a₁₃⊗78+a₁₂⊗26+a₁₁⊗187+a₁₀⊗46+a₉⊗241+a₈⊗190+a₇⊗212+a₆⊗175+a₅⊗55+a₄⊗177+a₃⊗212+a₂⊗42+a₁⊗110+a₀⊗184

c₇=a₁₅⊗184+a₁₄⊗73+a₁₃⊗135+a₁₂⊗20+a₁₁⊗203+a₁₀⊗141+a₉⊗171+a₈⊗73+a₇⊗9+a₆⊗108+a₅⊗42+a₄⊗1+a₃⊗96+a₂⊗142+a₁⊗75+a₀⊗93

c₆=a₁₅⊗93+a₁₄⊗212+a₁₃⊗184+a₁₂⊗47+a₁₁⊗141+a₁₀⊗18+a₉⊗238+a₈⊗246+a₇⊗8+a₆⊗84+a₅⊗15+a₄⊗243+a₃⊗152+a₂⊗200+a₁⊗127+a₀⊗39

c₅=a₁₅⊗39+a₁₄⊗159+a₁₃⊗190+a₁₂⊗104+a₁₁⊗26+a₁₀⊗124+a₉⊗173+a₈⊗201+a₇⊗132+a₆⊗47+a₅⊗235+a₄⊗254+a₃⊗198+a₂⊗72+a₁⊗162+a₀⊗189

c₄=a₁₅⊗189+a₁₄⊗149+a₁₃⊗94+a₁₂⊗48+a₁₁⊗233+a₁₀⊗96+a₉⊗191+a₈⊗16+a₇⊗239+a₆⊗57+a₅⊗236+a₄⊗145+a₃⊗127+a₂⊗72+a₁⊗137+a₀⊗16

c₃=a₁₅⊗6+a₁₄⊗233+a₁₃⊗208+a₁₂⊗217+a₁₁⊗243+a₁₀⊗148+a₉⊗61+a₈⊗175+a₇⊗123+a₆⊗255+a₅⊗100+a₄⊗145+a₃⊗82+a₂⊗248+a₁⊗13+a₀⊗221

c₂=a₁₅⊗221+a₁₄⊗153+a₁₃⊗117+a₁₂⊗202+a₁₁⊗151+a₁₀⊗68+a₉⊗90+a₈⊗224+a₇⊗48+a₆⊗166+a₅⊗49+a₄⊗211+a₃⊗223+a₂⊗72+a₁⊗100+a₀⊗132

c₁=a₁₅⊗132+a₁₄⊗45+a₁₃⊗116+a₁₂⊗150+a₁₁⊗93+a₁₀⊗119+a₉⊗111+a₈⊗222+a₇⊗84+a₆⊗180+a₅⊗141+a₄⊗209+a₃⊗68+a₂⊗60+a₁⊗165+a₀⊗148

c₀=a₁₅⊗148+a₁₄⊗32+a₁₃⊗133+a₁₂⊗16+a₁₁⊗194+a₁₀⊗192+a₉⊗1+a₈⊗251+a₇⊗1+a₆⊗192+a₅⊗194+a₄⊗16+a₃⊗133+a₂⊗32+a₁⊗148+a₀⊗1

In the above expressions, cᵢ represents the i-th byte in the linear transformation result, which contains eight data bits. For each cᵢ, eight XOR combinational logic circuits can be configured to obtain eight data bits in the cᵢ, the quantity of XOR gates contained in each XOR combinational logic circuit and the input data bits are determined by the cᵢ expression. In this embodiment, 128 XOR combinational logic circuits can be configured to obtain a total of 128 data bits in c₀ to C₁₅ in a parallel manner to obtain the linear transformation result.

For example, c₁₅ contains eight data bits, respectively c₁₅[0], c₁₅[1], . . . , c₁₅[7], of which the 8th data bit c₁₅[7] is the 128th data bit in the linear transformation result. According to the expression of c₁₅, the XOR combinational logic circuit A₁₂₈ for acquiring c₁₅[7] contains 71 XOR gates, the 71 XOR gates are configured to perform the following XOR operation to obtain c₁₅[7]:
a₁₅[6]\hat{ }a₁₅[5]\hat{ }a₁₅[4]\hat{ }a₁₅[3]\hat{ }a₁₅[2]\hat{ }a₁₅[0]a₁₄[5]\hat{ }a₁₄[4]\hat{ }a₁₄[1]\hat{ }a₁₄[0]a₁₃[6]\hat{ }a₁₃[5]\hat{ }a₁₃[1]a₁₂[6]
\hat{ }a₁₂[5]\hat{ }a₁₂[4]\hat{ }a₁₂[3]\hat{ }a₁₂[2]\hat{ }a₁₂[1]\hat{ }a₁₂[0]a₁₁[7]\hat{ }a₁₁[6]\hat{ }a₁₁[1]\hat{ }a₁₁[0]a₁₀[6]\hat{ }a₁₀[3]\hat{ }a₁₀[1]\hat{ }a₁₀[0]a₉[7]\hat{ }a₉[4]\hat{ }a₉[3]\hat{ }a₉[0]a₈[4]\hat{ }a₈[3]\hat{ }a₈[0]a₇[6]\hat{ }a₇[5]\hat{ }a₇[4]a₆[6]\hat{ }a₆[5]\hat{ }a₆[4]\hat{ }a₆[3]\hat{ }a₆[2]\hat{ }a₆[1]\hat{ }a₆[0]p1 a₅[7]\hat{ }a₅[6]\hat{ }a₅[5]\hat{ }a₅[4]\hat{ }a₅[3]\hat{ }a₅[0]a₄[2]\hat{ }a₄[1]\hat{ }a₄[0]a₃[7]\hat{ }a₃[6]\hat{ }a₃[5]\hat{ }a₃[4]\hat{ }a₃[0]a₂[6]\hat{ }a₂[3]\hat{ }a₂[1]\hat{ }a₂[0]a₁[7]\hat{ }a₁[6]\hat{ }a₁[5]\hat{ }a₁[2]\hat{ }a₁[1]a₀[7]\hat{ }a₀[6]\hat{ }a₀[3]\hat{ }a₀[1], wherein “\hat{ }” represents an XOR operation, a₀[1], a₀[3], a₀[6], a₀[7], a₁[1], . . . , a₁₅[5], and a₁₅[6] are the input data of the XOR combinational logic circuit A₁₂₈.

The above mentioned XOR combinational logic circuit A₁₂₈ can be implemented using the multiple stages of XOR combinational logic units.

For example, the first-stage XOR combinational logic unit implements the following XOR operations:
a₁₅[6]\hat{ }a₁₅[5]\hat{ }a₁₅[4]\hat{ }a₁₅[3]\hat{ }a₁₅[2]\hat{ }a₁₅[0], whose result is recorded as A1.1;
a₁₄[5]\hat{ }a₁₄[4]\hat{ }a₁₄[1]\hat{ }a₁₄[0], whose result is recorded as A1.2;
a₁₃[6]\hat{ }a₁₃[5]\hat{ }a₁₃[1], whose result is recorded as A1.3;
a₁₂[6]\hat{ }a₁₂[5]\hat{ }a₁₂[4]\hat{ }a₁₂[3]\hat{ }a₁₂[2]\hat{ }a₁₂[1]\hat{ }a₁₂[0], whose result is recorded as A1.4;
a₁₁[7]\hat{ }a₁₁[6]\hat{ }a₁₁[1]\hat{ }a₁₁[0], whose result is recorded as A1.5;
a₁₀[6]\hat{ }a₁₀[3]\hat{ }a₁₀[1]\hat{ }a₁₀[0], whose result is recorded as A1.6;
a₉[7]\hat{ }a₉[4]\hat{ }a₉[3]\hat{ }a₉[0], whose result is recorded as A1.7;
a₈[4]\hat{ }a₈[3]\hat{ }a₈[0], whose result is recorded as A1.8;
a₇[6]\hat{ }a₇[5]\hat{ }a₇[4], whose result is recorded as A1.9;
a₆[6]\hat{ }a₆[5]\hat{ }a₆[4]\hat{ }a₆[3]\hat{ }a₆[2]\hat{ }a₆[1]\hat{ }a₆[0], whose result is recorded as A1.10;
a₅[7]\hat{ }a₅[6]\hat{ }a₅[5]\hat{ }a₅[4]\hat{ }a₅[3]\hat{ }a₅[0], whose result is recorded as A1.11;
a₄[2]\hat{ }a₄[1]\hat{ }a₄[0], whose result is recorded as A1.12;
a₃[7]\hat{ }a₃[6]\hat{ }a₃[5]\hat{ }a₃[4]\hat{ }a₃[0], whose result is recorded as A1.13;
a₂[6]\hat{ }a₂[3]\hat{ }a₂[1]\hat{ }a₂[0], whose result is recorded as A1.14;
a₁[7]\hat{ }a₁[6]\hat{ }a₁[5]\hat{ }a₁[2]\hat{ }a₁[1], whose result is recorded as A1.15;
a₀[7]\hat{ }a₀[6]\hat{ }a₀[3]\hat{ }a₀[1], whose result is recorded as A1.16.

In the operations performed in the first-stage XOR combinational logic unit described above, the maximum quantity of combinational logic XOR units used in each step is 8.

The second-stage XOR combinational logic unit is configured to implement the following XOR operations:
A1.1\hat{ }A1.2, whose result is recorded as A2.1;
A1.3\hat{ }A1.4, whose result is recorded as A2.2;
A1.5\hat{ }A1.6, whose result is recorded as A2.3;
A1.7\hat{ }A1.8, whose result is recorded as A2.4;
A1.9\hat{ }A1.10, whose result is recorded as A2.5;
A1.11\hat{ }A1.12, whose result is recorded as A2.6;
A1.13\hat{ }A1.14, whose result is recorded as A2.7;
A1.15\hat{ }A1.16, whose result is recorded as A2.8.

In the operations performed in the second-stage XOR combinational logic unit described above, the quantity of the XOR combinational logic unit used in each step is 1.

The third-stage XOR combinational logic unit is configured to implement the following XOR operations:
A2.1\hat{ }A2.2, whose result is recorded as A3.1;
A2.3\hat{ }A2.4, whose result is recorded as A3.2;
A2.5\hat{ }A2.6, whose result is recorded as A3.3;
A2.7\hat{ }A2.8, whose result is recorded as A3.4.

In the operations performed in the third-stage XOR combinational logic unit described above, the quantity of the XOR combinational logic unit used in each step is 1.

The fourth-stage XOR combinational logic unit is configured to implement the following XOR operations:
A3.1\hat{ }A3.2, whose result is recorded as A4.1;
A3.3\hat{ }A3.4, whose result is recorded as A4.2.

In the operations performed in the fourth-stage XOR combinational logic unit described above, the quantity of the XOR combinational logic unit used in each step is 1.

The fifth-stage XOR combinational logic unit is configured to implement the following XOR operations:
A4.1\hat{ }A4.2, whose result is recorded as A5.1.

In the operations performed in the fifth-stage XOR combinational logic unit described above, the quantity of the XOR combinational logic unit used in each step is 1. A5.1 is the result of the computation of the XOR combinational logic circuit A₁₂₈. From this, a total of 8+1+1+1+1=12 stages of XORs are required to implement the XOR combinational logic circuit A₁₂₈.

In summary, the present disclosure provides the linear converter. The linear converter multiplies the data block with the constant coefficient matrix in the Galois Field for one time to obtain the linear transformation result. The present disclosure effectively shortens the length of the linear transformation process, which is conducive to reducing the delay of the block encryption or block decryption process.

In addition, the linear converter of the present disclosure can be implemented using n XOR combinational logic circuits, the n XOR combinational logic circuits can provide n data bits of the linear transformation result in a parallel manner. In addition, n XOR combinational logic circuits may be implemented using multi-stage XOR combinational logic units, when the XOR combinational logic unit contains multiple XOR gates, these XOR gates can process the input data bits in a parallel manner. In the above manner, the delay of the combinational logic can be effectively reduced, thereby further reducing the delay of the block encryption or decryption process.

Furthermore, the linear converter provided by the embodiment of the present disclosure does not rely on substitution tables when performing the linear transformation, and thus does not require additional resources to calculate and store substitution tables, which is conducive to reducing the resource overhead.

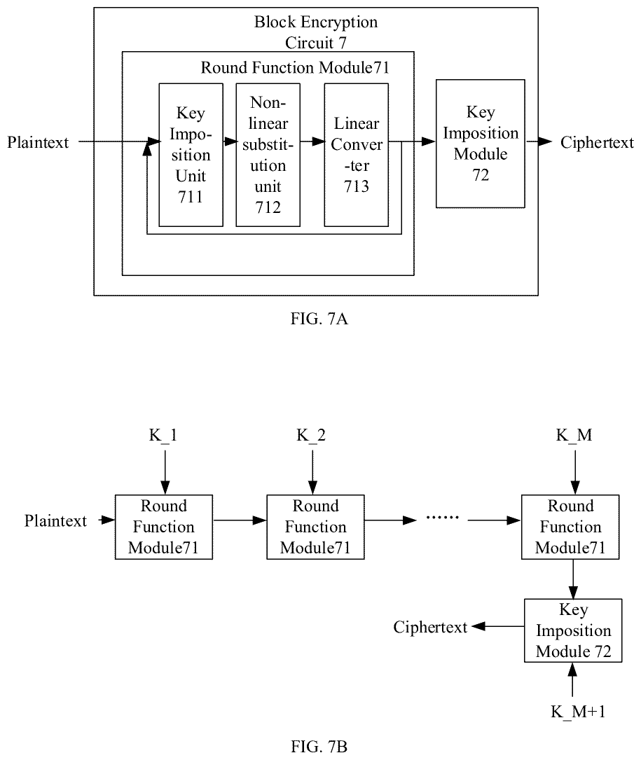

The present disclosure also provides a block encryption circuit. FIG. 7A shows a schematic diagram of a structure of the block encryption circuit 7 according to an embodiment of the present disclosure. As shown in FIG. 7A, the block encryption circuit 7 includes a round function module 71 and a key imposition module 72, wherein the round function module 71 includes a key imposition unit 711, a non-linear substitution unit 712, and a linear converter 713, and the linear converter 713 may be the linear converter provided by the present disclosure. The key imposition unit 711, the non-linear substitution unit 712, and the linear converter 713 are configured to perform key imposition, non-linear substitution, and linear transformation processes on data, respectively.

FIG. 7B shows a schematic diagram of the block encryption process applied in an embodiment of the present disclosure. As shown in FIG. 7B, the plaintext data is input into the round function module 71. The round function module 71 processes the plaintext data with the key K_1 to obtain a first encrypted intermediate data. The first encrypted intermediate data is input to the next round function module 71, which processes the first encrypted intermediate data with a key K_2 to obtain a second encrypted intermediate data. And so on, until the M-th encrypted intermediate data is obtained. The M-th encrypted intermediate data is input into the key imposition module 72. The key imposition module 72 performs key imposition operation on the M-th encrypted intermediate data using the key K_M+1 to obtain a ciphertext, where M is a positive integer, with a numeric value of 9, for example.

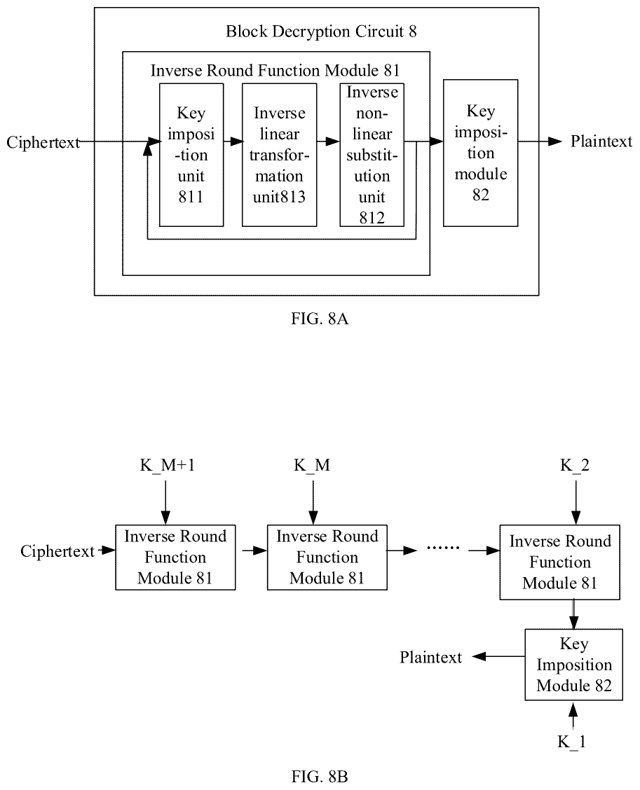

The present disclosure also provides a block decryption circuit. FIG. 8A shows a schematic diagram of a structure of the block decryption circuit 8 according to the present disclosure. As shown in FIG. 8A, the block decryption circuit 8 includes an inverse round function module 81 and a key imposition module 82, wherein the inverse round function module 81 includes a key imposition unit 811, an inverse linear transformation unit 813, and an inverse non-linear substitution unit 812. The inverse linear transform unit 813 may be implemented by a linear converter and a reordering circuit provided in an embodiment of the present disclosure. The key imposition unit 811, the inverse non-linear substitution unit 812, and the inverse linear transformation unit 813 are configured to perform key imposition, inverse non-linear substitution, and inverse linear transformation operation on data.

FIG. 8B shows a schematic diagram of a block decryption process applied in an embodiment of the present disclosure. As shown in FIG. 8B, the ciphertext data is input to the inverse round function module 81. The inverse round function module 81 processes the ciphertext data with the key K_M+1 to obtain the first decrypted intermediate data. The first decrypted intermediate data is input to an inverse round function module 81, which processes the first decrypted intermediate data with a key K_M to obtain the second decrypted intermediate data. And so on, until the M-th decrypted intermediate data is obtained. The M-th decrypted intermediate data is input into the key imposition module 82. The key imposition module 82 uses the key K_1 to apply a key imposition to the M-th decrypted intermediate data to obtain plaintext.

The present disclosure also provides a chip comprising at least a portion of the linear converter, the block encryption circuit, or the block decryption circuit. The chip may be represented as a marketable active device that encapsulates the linear converter, the block encryption circuit, or the block decryption circuit manufactured on a wafer using semiconductor technology; or as a marketable active device that encapsulates the linear converter, the block encryption circuit, or the block decryption circuit using printed circuit board (PCB) packaging technology.

The descriptions of the processes or structures corresponding to the various Figs may emphasize different aspects. Parts not detailed in a particular process or structure can be referenced in the descriptions of other relevant processes or structures.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A linear converter, applied to block encryption circuit and/or decryption circuit, wherein the linear converter is configured to multiply a data block in the block encryption circuit and/or decryption circuit with a constant coefficient matrix in the Galois Field for one time to obtain a linear transformation result, and elements in the constant coefficient matrix are obtained according to transformation coefficients of a basic transformation.

2. The linear converter according to claim 1, wherein the linear converter comprises n Exclusive-OR (XOR) combinational logic circuits, each of the XOR combinational logic circuits is configured to perform operations on corresponding data bits in the data block in stage to obtain 1 bit of data in the linear transformation result, wherein n is a positive integer, and n is determined by the quantity of data bits comprised in the data block.

3. The linear converter according to claim 2, wherein the XOR combinational logic circuits comprise multiple XOR gates, wherein the quantity of XOR gates and their corresponding data bits are determined by corresponding elements in the constant coefficient matrix.

4. The linear converter according to claim 2, wherein the XOR combinational logic circuits comprise multiple stages of XOR combinational logic units, each stage of the XOR combinational logic units comprises at least one XOR gate.

5. The linear converter according to claim 4, wherein multiple XOR gates in XOR combinational logic units of the same stage perform XOR operations on the input data bits in a parallel manner.

6. The linear converter according to claim 2, wherein the n XOR combinational logic circuits obtain n data bits of the linear transformation result in parallel.

7. The linear converter according to claim 1, wherein a length of the data block is 128 bits.

8. The linear converter according to claim 1, wherein the constant coefficient matrix is determined by:
determining a transformation matrix C based on R(a)=(l(a_{ƒ-1}, a_{ƒ-2}, . . . , a₀)∥a_{ƒ-1}∥. . . ∥a₁) and the transformation coefficients of the basic transformation l, in stage to get R(a)=[a_{ƒ-1}, a_{ƒ-2}, . . . , a₀]⊗C, wherein R represents the linear transformation, l represents the basic transformation, a represents the data block, aᵢ represents a i -th byte of the data block a, and ƒ represents a quantity of bytes of the data block a; and
determining the constant coefficient matrix based on the transformation matrix C and a quantity of rounds nr for which R is to be transformed.

9. The linear converter according to claim 8, wherein the constant coefficient matrix is equivalent to the transformation matrix C raised to the power of nr.

10. A block encryption circuit, comprising:
a round function module, configured to perform multiple rounds of operation on plaintext data to obtain encrypted intermediate data; and
a key imposition module, configured to process the encrypted intermediate data using a key to obtain a ciphertext;
wherein, the round function module comprises a key imposition unit, a non-linear substitution unit, and the linear converter as claimed in claim 1.

11. A block decryption circuit, comprising:
an inverse round function module, configured to perform multiple rounds of operation on ciphertext data to obtain decrypted intermediate data; and
a key imposition module, configured to process the decrypted intermediate data using a key to obtain plaintext;
wherein, the inverse round function module comprises a key imposition unit, a non-linear substitution unit, and an inverse linear transformation unit, the inverse linear transformation unit comprises the linear converter as claimed in claim 1.

12. A chip, comprising: the linear converter as claimed in claim 1, a block encryption circuit, or a block decryption circuit;
wherein the block encryption circuit comprises: a round function module, configured to perform multiple rounds of operation on plaintext data to obtain encrypted intermediate data; and a key imposition module, configured to process the encrypted intermediate data using a key to obtain a ciphertext; wherein, the round function module comprises a key imposition unit, a non-linear substitution unit, and the linear converter;
wherein the block decryption circuit comprises: an inverse round function module, configured to perform multiple rounds of operation on ciphertext data to obtain decrypted intermediate data; and a key imposition module, configured to process the decrypted intermediate data using a key to obtain plaintext; wherein, the inverse round function module comprises a key imposition unit, a non-linear substitution unit, and an inverse linear transformation unit, the inverse linear transformation unit comprises the linear converter.
